(19) United States
(12) Patent Application Publication
(10) Pub. No.: US 2025/0088522 A1
(43) Pub. Date: Mar. 13, 2025

(54) THREAT DETECTION IMPLEMENTED IN A DATA PROCESSING UNIT

(71) Applicant: Dell Products, L.P., Round Rock, TX (US)

(72) Inventors: Jonathan Krasner, Coventry, RI (US); Ramesh Doddaiah, Westborough, MA (US)

(21) Appl. No.: 18/462,774

(22) Filed: Sep. 7, 2023

(51) Int. Cl. H04L 9/40; H04L 41/16

(52) U.S. Cl. CPC H04L 63/1425; H04L 41/16; H04L 63/145

(57) ABSTRACT

Architectures and techniques are described that can provide security or threat detection for a data storage system. Threat detection can be identified and potentially blocked prior to requested customer workloads reaching a backend storage device and can thus effectively be achieved in real-time. Techniques utilized herein can leverage an offload capability that operates to offload certain processing from a central processing unit (CPU) to a data processing unit (DPU). A long short-term memory (LSTM) model can be executed in the DPU to detect potential threats in real-time without consuming CPU resources.

### BACKGROUND

Providers of network services, such as data storage or data warehousing, seek to provide a high level of service to customers and/or clients. For example, such providers attempt to ensure that a customer's data is reliably and securely stored and that availability of the customer's data is consistently maintained. A challenge that confronts storage service providers or other network service providers is the potential for malicious actors to interfere in some way with the network service. A common example in the context of data storage services is known as a ransomware attack, which leverages malicious software that seeks to encrypt customer data, rendering such data inaccessible to the customer unless a ransom is paid.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 depicts a schematic block diagram illustrating a non-limiting example data storage service architecture in accordance with certain embodiments of this disclosure;

FIG. 2 depicts a schematic block diagram illustrating an example server device in which customer workloads are offloaded to a data processing unit (DPU) where threat detection is performed in accordance with certain embodiments of this disclosure;

FIG. 3 depicts a schematic block diagram illustrating various examples of time-series data in accordance with certain embodiments of this disclosure;

FIG. 4 depicts a schematic block diagram illustrating an example DPU that utilizes a long short-term memory (LSTM) model to facilitate threat detection and mitigation in accordance with certain embodiments of this disclosure;

FIG. 5 depicts a schematic block diagram illustrating various examples of time-series patterns in accordance with certain embodiments of this disclosure;

FIG. 6 depicts a schematic block diagram illustrating an example device that can provide threat mitigation based on pattern anomaly detection in accordance with certain embodiments of this disclosure;

FIG. 7 depicts a schematic block diagram illustrating the example device that can provide threat mitigation based on pattern matching with a malicious pattern in accordance with certain embodiments of this disclosure;

FIG. 8 illustrates an example method that can provide threat detection and mitigation based on an LSTM model running in a DPU in accordance with certain embodiments of this disclosure;

FIG. 9 illustrates an example method that can provide for additional aspect or elements in connection with threat detection and mitigation based on an LSTM model running in a DPU in accordance with certain embodiments of this disclosure;

FIG. 10 illustrates a block diagram of an example distributed file storage system that employs tiered cloud storage in accordance with certain embodiments of this disclosure; and

FIG. 11 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

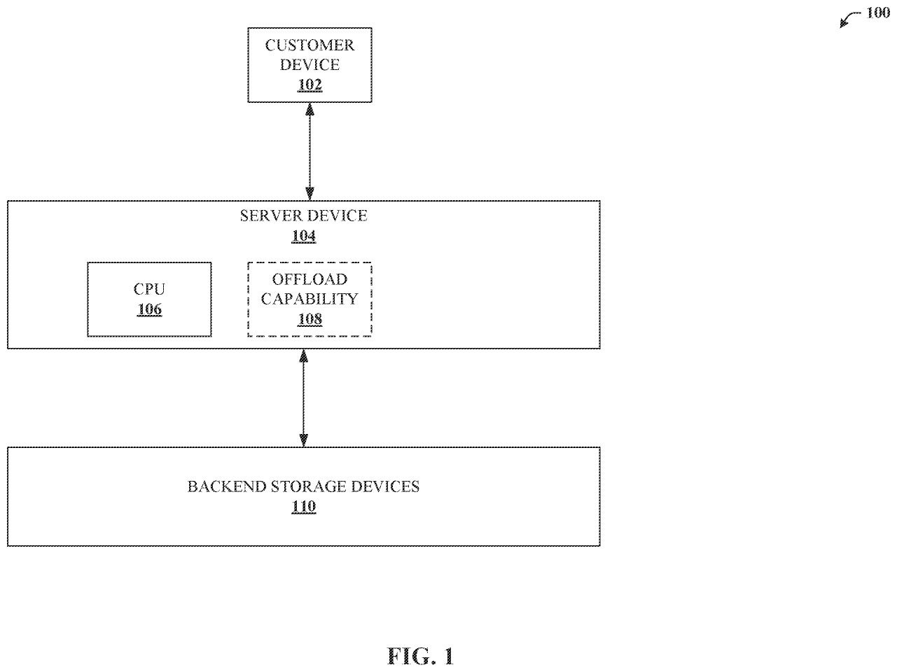

To better explain the disclosed techniques, it can be instructive to consider an example data storage service architecture. FIG. 1 depicts a schematic block diagram 100 illustrating an example data storage service architecture in accordance with certain embodiments of this disclosure. Typically, customer data can be stored in backend storage devices 110, which can conceptually represent devices of a data storage facility or the like. In some embodiments, backend storage devices 110 can represent physical devices of a centralized or cloud-based storage array.

Additionally, the architecture can include a server device 104. Server device 104 can serve files for customers, such as for one or more customer device(s) 102. Conceptually, server device 104 can represent an interface between customer device 102 and backend storage devices 110. Server device 104 can comprise a central processing unit (CPU) 106 to handle many operations such as caching operations and backend input/output (IO) transactions.

In modern IT infrastructures, server device 104 can be situated at a network edge that can be geographically or topologically nearer to customer device 102 than backend storage devices 110. As one result, server device 104 may not have the computational resources that are extant at facilities associated with backend storage devices 110. Hence, a trend has emerged to provide offload capabilities 108 to server device 104 such that some portion of, or certain types of, transactions processed by CPU 106 can be offloaded to other devices or equipment, which can free up CPU 106 for more specialized tasks and potentially increase efficiency.

For example, in today's fast paced and growing IT infrastructures, security threat intrusion and exploitations are becoming more prevalent, and sometimes catastrophic to IT businesses that cannot manage the in-flux of security threats, and even worse having an IT business held hostage until a ransom is paid due to the propagation of ransomware. Today, most of the security threats that face businesses are detected and reported after the fact, which is typically too late. Some businesses may be lucky and have enough time to react and take appropriate action. But most do not have that opportunity. Compounding this situation is that workloads are funneled into a storage array system that can be disaggregated and unchecked in cases where local and/or offload capabilities cannot perform at optimum speeds such as at the edge of an IoT system or another system.

Unfortunately, even with offload capabilities 108 in place, many edge devices or other suitable devices such as server device 104 simply may not have the computational resources or other resources sufficient to perform detect and/or mitigate many security threats in an online fashion or real-time fashion, or otherwise before a given customer workload reaches backend storage devices 110.

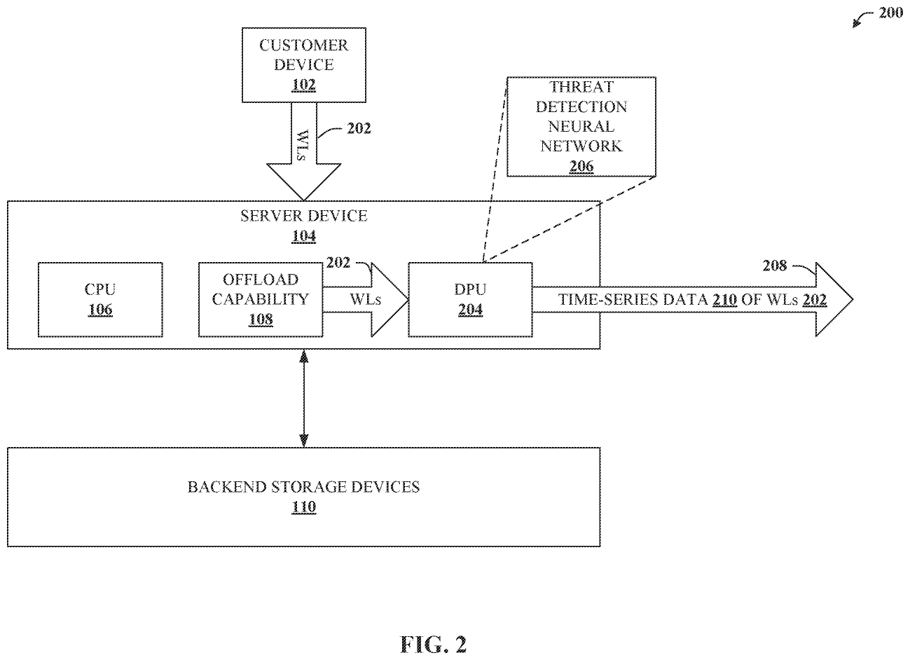

While edge computing and having offload capabilities 108 is gaining traction in an IT driven world, currently, offload capabilities 108 tend to be at a lower scale for power and cost reasons. Such poses a significant risk because there can exist cases in which offloading at the edge cannot process real-time deterministic patterns of data that could represent a security breach within the IT environment until after the fact. In to mitigate these and other potential security threats, the disclosed techniques are directed to leveraging the offload capabilities 108 of server device 104 (e.g., an edge server) to offload threat detection from CPU 106 to a data processing unit (DPU), which is further detailed in connection with FIG. 2.

### Example Systems

Referring now to FIG. 2, a schematic block diagram 200 is depicted illustrating an example server device in which customer workloads are offloaded to a DPU where threat detection is performed in accordance with certain embodiments of this disclosure. Similar to FIG. 1, server device 104 can receive one or more workloads 202 from one or more customer devices 102. Server device 104 can be situated at a network edge, a data center, a data service facility, or elsewhere. Based on offload capability 108, all or a portion of customer workloads 202 can be provided to DPU 204.

Typically, a DPU, (e.g., DPU 204) can be a specialized programmable computing device or processor that tightly integrates with a general-purpose CPU such as CPU 106 of server device 104. Commonly, a DPU can include network interface hardware that can be specialized for networking and communication workloads thereby freeing up CPU 106 for other tasks. Generally, DPU's are intended to handle data transfers, data compression, data encryption, data storage, and even data analytics. In addition to common DPU usage, DPU 204 can, in accordance with the disclosed subject matter, also be utilized for threat detection.

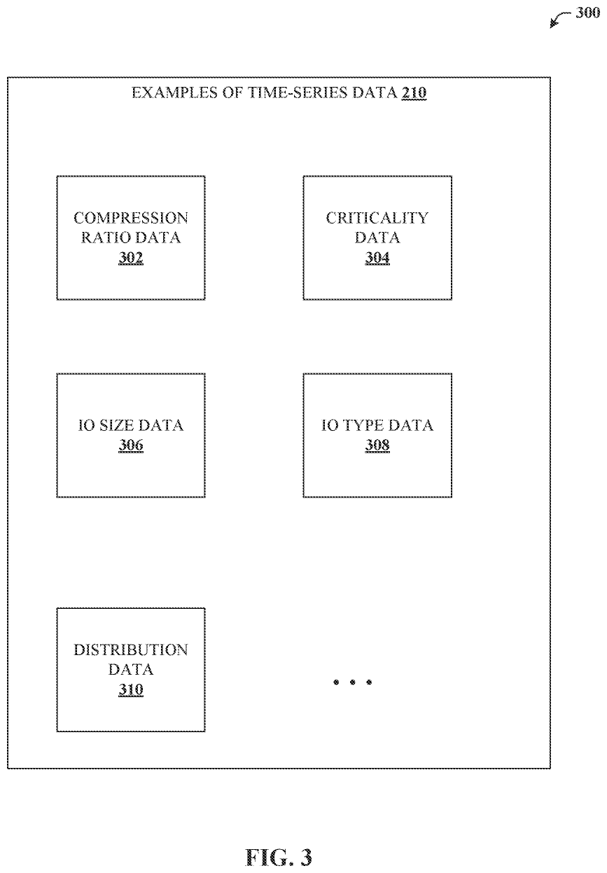

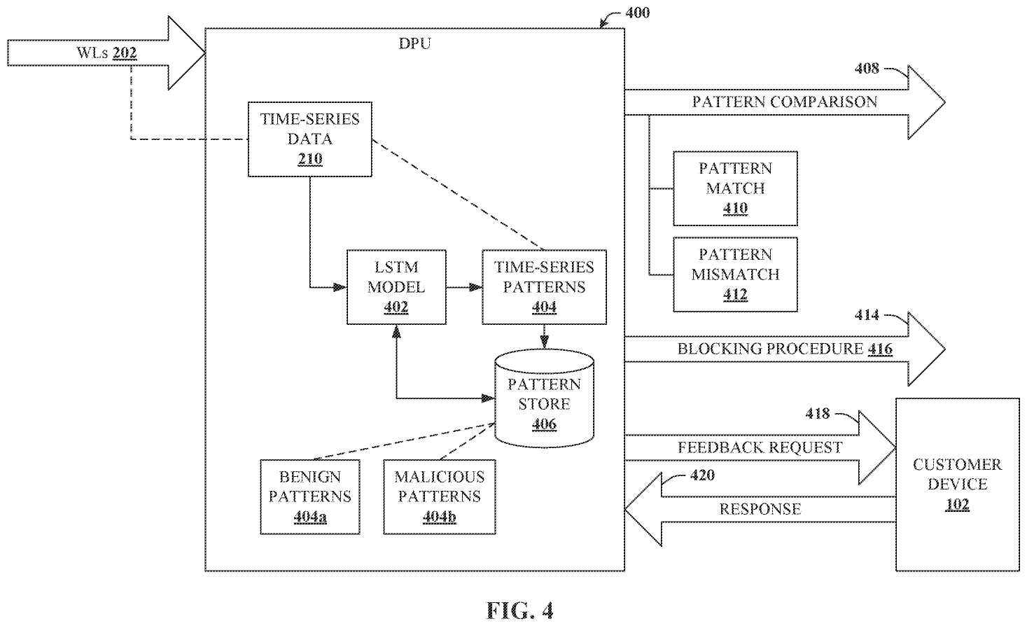

For example, DPU 204 can comprise all or a portion of a threat detection neural network 206. Threat detection neural network 206 can be an artificial intelligence (AI) and/or machine learning (ML) model designed to detect potential threats. In some embodiments, the threat detection neural network 206 can be a long short-term memory (LSTM) model, as discussed in connection with FIG. 4. As illustrated, DPU 204 can receive customer workloads 202 (e.g., via offload capability 108) and generate time-series data 210 from the customer workloads 202. Time-series data 210 can be any suitable data that includes a time dimension or, in some cases, manifests as a time-based ordering. Various examples of time-series data 210 can be found with reference to FIG. 3.

With reference now to FIG. 3, a schematic block diagram 300 is depicted illustrating various examples of time-series data 210 in accordance with certain embodiments of this disclosure. For example, in some embodiments, time-series data 210 can be compression ratio data 302. Compression ratio data 302 can be indicative of compression ratios of IO transactions over time, where the IO transactions can be those indicated by a given workload 202.

In some embodiments, time-series data 210 can be criticality data 304. Criticality data 304 can be indicative of a priority or weight associated with an element of time-series data 210. In some embodiments, time-series data 210 can be IO size data 306. IO size data 306 can be indicative of data sizes associated with IO transactions over time. For example, an order or sequence of differing IO sizes can be observed when plotted in the time domain.

In some embodiments, time-series data 210 can be IO type data 308. IO type data 308 can be indicative of various types of the IO transactions over time. Such can include reads, writes, renames, deletes, or any other suitable transaction type. When plotting this information in the time domain, such can establish an order or sequence of the various types of the IO transactions associated with a given workload 202.

In some embodiments, time-series data 210 can be distribution data 310. Distribution data 310 can be indicative of a distribution of the types of the IO transactions over time. For example, distribution data 310 can indicate a ratio of read transactions versus write transactions over time, or similar.

Turning now to FIG. 4, a schematic block diagram is depicted illustrating an example DPU 400 that utilizes a long short-term memory (LSTM) model to facilitate threat detection and mitigation in accordance with certain embodiments of this disclosure. For example, various customer workloads 202 can be offloaded by a CPU to DPU 400. As explained previously, time-series data 210 can be determined or captured for the workloads 202.

Time-series data 210 can be input to LSTM model 402 from which various time-series patterns 404 can be determined. LSTM model 402 is a type of recurrent neural network that is capable of learning order dependence in sequence prediction typically used in domains such as language translation or handwriting/speech recognition. Since time-series patterns 404 generated from customer workloads 202 are expected to repeat, or at least relevant to identify when such patterns do (or do not) repeat, LSTM model 402 can be utilized in accordance with the disclosed techniques.

Unlike other recurrent neural networks, LSTM model 402 does not suffer from a vanishing gradient problem and can adapt to large differences in time windows. Since time-series patterns 404 are expected to recur at some later time in order to represent a trend or seasonality, it may be that the recurrence is short term (e.g., minutes) or long term (e.g., weeks or months). Such can cause difficulties with other types of models in the context of the disclosed pattern-based inferences. However, such can also illustrate a natural fit for LSTM model 402, which can be capable of highly scaling the number of data inputs to keep track of previous states and to determine when long and/or short-time dependencies are to be selected.

Data from the current time (e.g., time-series patterns 404 generated from a current workload 202) is more likely to be related to a recent point in time, or some time further in the past. Moreover, having DPU 400 capabilities can facilitate the decisions utilized to detect a security anomaly and/or threat in real-time based on pattern-driven inferences or other criteria, any of which can change at a moment's notice and new attacks may occur in a different data stream.

With respect to time-series patterns 404 generated from workloads 202, in some embodiments, time-series patterns 404 can be stored to a memory associated with DPU 400, indicated here as pattern store 406. Thus, time-series patterns 404 can be indicative of patterns that are observed for customer workloads 202, namely, patterns observed in the time-series data 210 of the associated workload 202.

Pattern store 406 can be any type of storage suitable for state information of previous workload 202 patterns. For example, in some embodiments, pattern store 406 can include time-series patterns 404 that are known or determined to be benign patterns 404a as well as those known or determined to be malicious patterns 404b. Benign patterns 404a can be indicative of ordinary time-series patterns 404 that are to be expected for a data storage array or service such as a defragmentation operation or workload. Malicious patterns 404b can be indicative of malicious activity or threats.

Both types of time-series patterns 404 (e.g., benign patterns 404a or malicious patterns 404b) can be included in pattern store 406. Time-series patterns 404 included in pattern store 406 can be pre-loaded by a provider based on modeling in lab conditions. Moreover, pre-loaded time-series patterns 404, once rolled out to serve customers, can be re-trained or fine-tuned based on specific time-series characteristics or other characteristics associated with a particular customer, which can be affected by a specific implementation, application, device, or even geographical location. New time-series patterns 404 can also be learned in the field and further refined using feedback or the like, as further explained below.

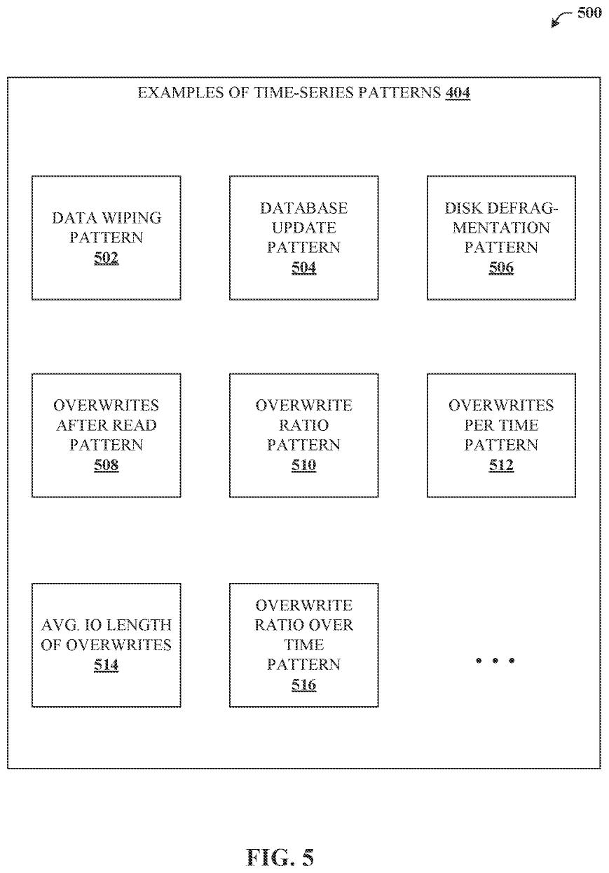

While still referring to FIG. 4, but turning now as well to FIG. 5, a schematic block diagram 500 is depicted illustrating various examples of time-series patterns 404 in accordance with certain embodiments of this disclosure. For example, most storage arrays have predefined general operations that can be resolved into examples of benign patterns 404a, which can include reference numerals 502-506 as examples.

For instance, in some embodiments, time-series patterns 404 can be data wiping pattern 502. A typical data wiping pattern commonly includes a repeated constant or predefined number of IO overwrites to completely wipe data from a disk. Such can be an example of benign pattern 404a, provided the time-series behavior does not deviate from expectation.

In some embodiments, time-series patterns 404 can be a database update pattern 504. Each different type of database can have a predefined pattern of IOs to update, which can be leveraged to determine database-specific update patterns. In some embodiments, time-series patterns 404 can be a disk defragmentation pattern 506. Generally, disk defragmentation patterns 506 include continuous block overwriting and data movement. Some can be local patterns based on a particular device or global patterns across many devices, but these types of patterns can be identified by LSTM model 402 based on time-series characteristics.

Moreover, LSTM model 402 can be trained in advance to detect known malicious patterns such as ransomware patterns or others. When the trained LSTM model 402 is pushed to the customer environment for real-time usage, LSTM model 402 can be further trained to learn to detect variations of the previously learned patterns to further improve real-time detection of ransomware or other malicious attacks. As such, certain malicious patterns 404b can be determined, examples including reference numerals 508-516.

For example, in some embodiments, reference numeral 508 can relate to a pattern that indicates a number of overwrites after reading a specific block or track within a time slice. As an illustrative example, the time slice can be, e.g., the last M seconds. In some embodiments, reference numeral 510 can relate to a pattern that indicates a fraction or ratio of overwritten blocks relative to the total number of write requests in a specific time window. The time window can include some number, N, of time slices.

In some embodiments, reference numeral 512 can relate to a pattern that indicates an amount of overwriting for a time window consisting of N different time slices. In some embodiments, reference numeral 514 can relate to a pattern that indicates an average IO length of continuously overwritten blocks in a given time window. In some embodiments, reference numeral 516 can relate to a pattern that indicates a fraction or ratio of the amount of overwriting during a specific time window over the average number of overwriting during a previous time window. These examples are intended to reflect non-limiting examples and other examples can exist.

Potentially any of these example patterns 502-516 can be pre-trained and/or developed in advance (e.g., based on training workloads 202) to reduce or mitigate false positives in the customer environment. Once pushed to the customer environment, LSTM model 402 can learn more patterns that are specific to customer workloads 202. The customer can be kept in the loop to provide recommendations to the LSTM model 402. LSTM model 402 can learn from both positive and negative feedback (e.g., from a human actor) in such a way that as time goes by the false positives are reduced and false negatives are improved by learning.

Further, LSTM model 402 can learn new variations that can be specific to the customer or specific to malicious code. Over time, LSTM model 402 can populate pattern store 406 with a substantial amount of information that can be sent over telemetry and new LSTM models can be trained on that information to improve further. In this way, LSTM models can learn generic patterns across different customer domains and improve the models across geographic regions as well.

Still referring to FIG. 4, LSTM model 402 can be a multivariate model that is trained on previously known patterns (e.g., in-house), potentially trained from previously updated patterns received via telemetry. Once pushed out to the customer environment, new patterns or variations can be learned and that additional knowledge can be shared through telemetry to improve LSTM model 402 potentially across all customer environments.

In response to generating time-series pattern 404 from a given workload 202, at reference numeral 408, DPU 400 can perform a pattern comparison. This pattern comparison compares the time-series patterns 404 generated from a current workload 202 to some pattern in pattern store 406 such as a stored pattern relating to those detailed in connection with patterns 502-516. It is noted that these could be either benign patterns 404a or malicious patterns 404b. During pattern comparison, the multivariate LSTM model 402 can facilitate detection of anomalies associated with read or write data chunks.

Such can result in a pattern match 410 or a pattern mismatch 412. As one example, a pattern mismatch 412 can occur when there is a bad bit or bad byte in the comparison output between the two patterns being compared. For example, consider the case in which some number, N, workloads 202 are associated with various time-series patterns 404. In addition, there can be other workloads 202 that may not have conforming patterns, but an inference model (e.g., LSTM model 402) running on DPU 400 can ingest the associated IO transactions and determine a set of patterns per device.

It is noted that DPU 400 can have memory regions that can be mapped to a database (e.g., pattern store 406) so that these data patterns can be referenced in real-time, as this data is zero-copy memory at the DPU level. Threat detection can take different forms based on the scenario. As one example, threat detection can take the form of a bit out of sequence for any of the indicated workloads 202. As another example, learned data patterns from random data workloads 202 can result in a bad bit or byte in the comparison output.

In either case, LSTM model 402 has the capability to self-adjust the timing window for each workload type, potentially based on the associated input criteria, thus allowing detection of pattern anomalies. In some cases, these pattern anomalies can trigger faster on one workload 202 over another workload 202 based on the criticality of the associated workload 202. Likewise, LSTM model 402 can detect in real time anomalies without utilizing CPU 106 resources and can prevent a particular (e.g., flagged) IO transaction from reaching down to the drive level (e.g., backend storage devices 110, thus avoiding corruption.

In some embodiments, the output of a pattern of a security threat can be posted to an IO channel and host indicating a source of origin so further action at that level can be performed. The disclosed techniques can also leverage a capability to shut down the IO channel to any backend storage devices 110.

In other words, if a threat is detected, then at reference numeral 414, blocking procedure 416 can be invoked that can block all or a portion of IO transactions associated with workload 202 before reaching backend storage devices 110. Thus, this LSTM model 402 implemented in DPU 400 can be capable of online or real-time detection.

Blocking procedure 416 can be configured according to a given customer policy. For example, workload 202 can be immediately blocked in some implementations. In other implementations workload 202 can be blocked after a certain amount of time, during which addition data can be collected or additional inferences can be made. During this time, feedback request 418 can be provided to the customer (e.g., via customer device 102) and a feedback response 420 can be received. In some embodiments, feedback request 418 can include to a description of the potential threat and a request for verification of some type such as whether the associated workload is a legitimate or benign operation. As indicated, response 420 can be used to further train LSTM model 402.

It is appreciated that threat identification can be the result of a pattern match 410 or a pattern mismatch 412 depending on the type of the stored pattern being compared. For instance, if the stored pattern being compared is a benign pattern 404a, then a pattern mismatch 412 can be indicative of a threat. On the other hand, if the stored pattern being compared is a malicious pattern 404b, then a pattern match 410 can be indicative of a threat.

It is further understood that customer patterns can be learned by LSTM model 402 such that various types of anomalous or malicious behavior can be identified, even the absence of workload 202. For example, suppose LSTM model 402 learns that a particular customer performs a backup operation every other weekend. Suppose on a given weekend, the expected backup operation does not occur. Such can be flagged as a potential anomaly and the customer informed (e.g., via feedback request 418).

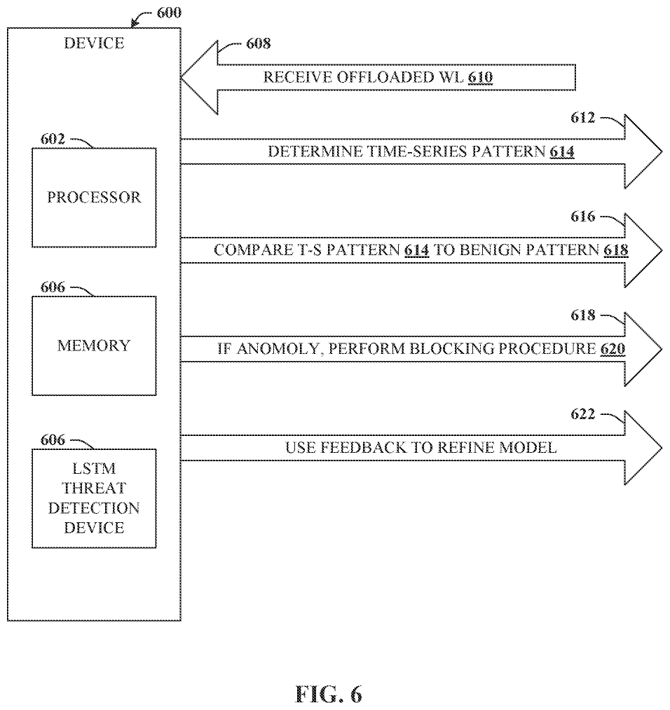

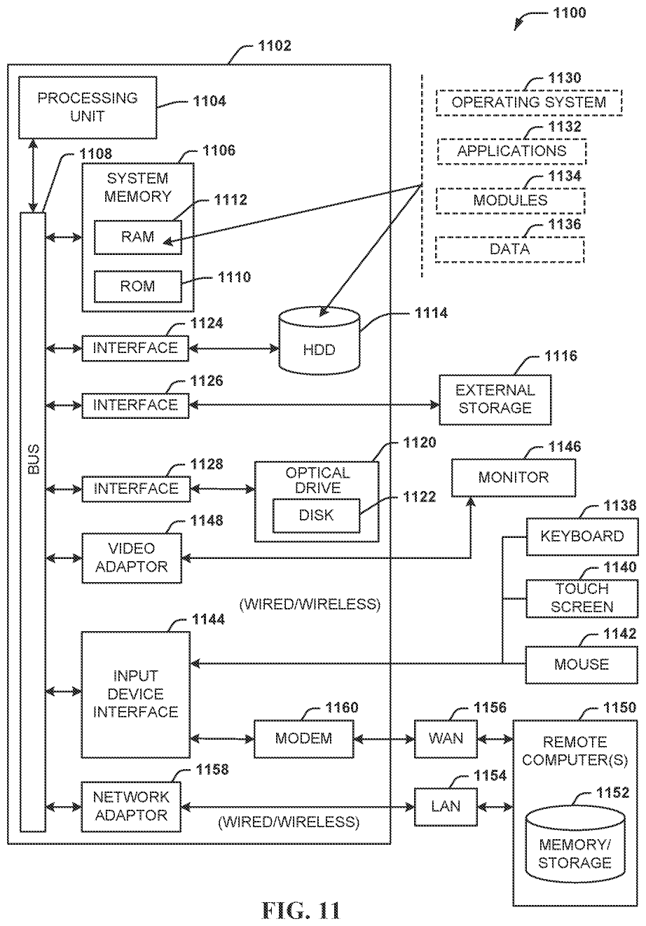

Referring now to FIG. 6, a schematic block diagram is depicted illustrating an example device 600 that can provide threat mitigation based on pattern anomaly detection in accordance with certain embodiments of this disclosure. In some embodiments, device 600 can be, or can be included in or communicatively coupled to, a DPU such as DPU 400. Device 600 can comprise a processor 602 that, potentially along with LSTM threat detection device 606, can be specifically configured to perform functions associated with mitigating potential attacks such as ransomware attacks. Device 600 can also comprise memory 604 that stores executable instructions that, when executed by processor 602, can facilitate performance of operations. Processor 602 can be a hardware processor having structural elements known to exist in connection with processing units or circuits, with various operations of processor 602 being represented by functional elements shown in the drawings herein that can require special-purpose instructions, for example, stored in memory 604 and/or LSTM threat detection device 606. Along with these special-purpose instructions, processor 602 and/or LSTM threat detection device 606 can be a special-purpose device. Further examples of the memory 604 and processor 602 can be found with reference to FIG. 11. It is to be appreciated that device 600 or computer 1102 can represent a server device or a client device of a network or network services platform and can be used in connection with implementing one or more of the systems, devices, or components shown and described in connection with FIG. 6 and other figures disclosed herein.

At reference numeral 608, device 600 can receive offloaded workload 610. For instance, offloaded workload 610 can be a customer workload received by a server device (e.g., server device 104) offloaded from a CPU (e.g., CPU 106) to device 600 (e.g., DPU 204 or DPU 400) via an offload capability (e.g., offload capability 108).

At reference numeral 612, device 600 can determine a time-series pattern 614 represented in workload 610. At reference numeral 616, device 600 can compare time-series pattern 614 represented in workload 610 to a baseline pattern generated from previously received workloads according to a LSTM model. In some embodiments, the baseline pattern being compared to can be benign pattern 618 that can be substantially similar to benign pattern 404a detailed above in connection with FIG. 4.

In response to an anomaly being detected in time-series pattern 614 relative to the baseline pattern, at reference numeral 618, device 600 can perform blocking procedure 620. In some embodiments, the anomaly can be indicated by a mismatched bit or byte associated with the comparison of the two time-series patterns. Since the anomaly can be detected in real-time, blocking procedure 620 can be configured to block IO transactions associated with workload 610 from reaching a particular device such as a backend storage device. Blocking procedure 620 can operate to block the IO transactions immediately or block the IO transactions after a defined time.

In some embodiments, at reference numeral 622, device 600 can use feedback from a customer entity or device to refine the LSTM model. In some embodiments, the LSTM model can comprise multiple layers of memory cells configured for scanning or forecasting short term and long term trends and seasonalities, or other time-series characteristics. In some embodiments, time-series pattern 614 can be determined in response to an examination of time-series data (e.g., time-series data 210) relating to IO transactions of workload 610.

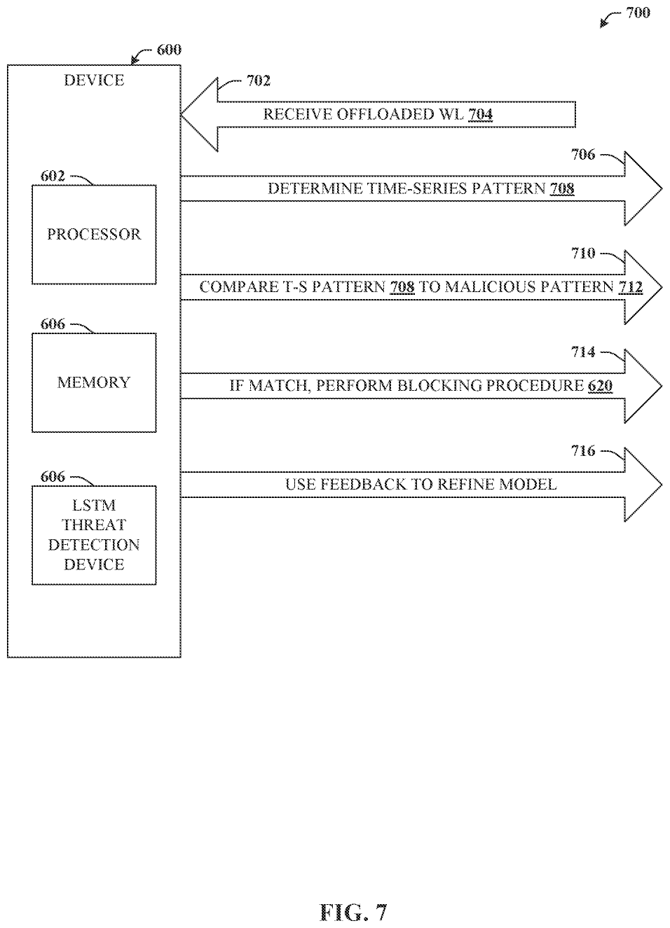

With reference now to FIG. 7, a schematic block diagram 700 is depicted illustrating the example device 600 that can provide threat mitigation based on pattern matching with a malicious pattern in accordance with certain embodiments of this disclosure.

At reference numeral 702, device 600 can receive offloaded workload 704. For instance, offloaded workload 704 can be a customer workload received by a server device (e.g., server device 104) offloaded from a CPU (e.g., CPU 106) to device 600 (e.g., DPU 204 or DPU 400) via an offload capability (e.g., offload capability 108).

At reference numeral 706, device 600 can determine a time-series pattern 708 applicable to workload 704. At reference numeral 710, device 600 can compare time-series pattern 708 represented in workload 704 to a malicious pattern 712 generated from previously received workloads according to a LSTM model. In some embodiments, malicious pattern 712 being compared to can be substantially similar to malicious pattern 404b detailed above in connection with FIG. 4.

In response to match being detected in time-series pattern 708 relative to the malicious pattern 712, at reference numeral 714, device 600 can perform blocking procedure 620, as substantially described in FIG. 6.

In some embodiments, at reference numeral 716, device 600 can use feedback from a customer entity or device to refine the LSTM model. In some embodiments, the LSTM model can comprise multiple layers of memory cells configured for scanning or forecasting short term and long term trends and seasonalities, or other time-series characteristics. In some embodiments, time-series pattern 708 can be determined in response to an examination of time-series data (e.g., time-series data 210) relating to IO transactions of workload 704.

### Example Methods

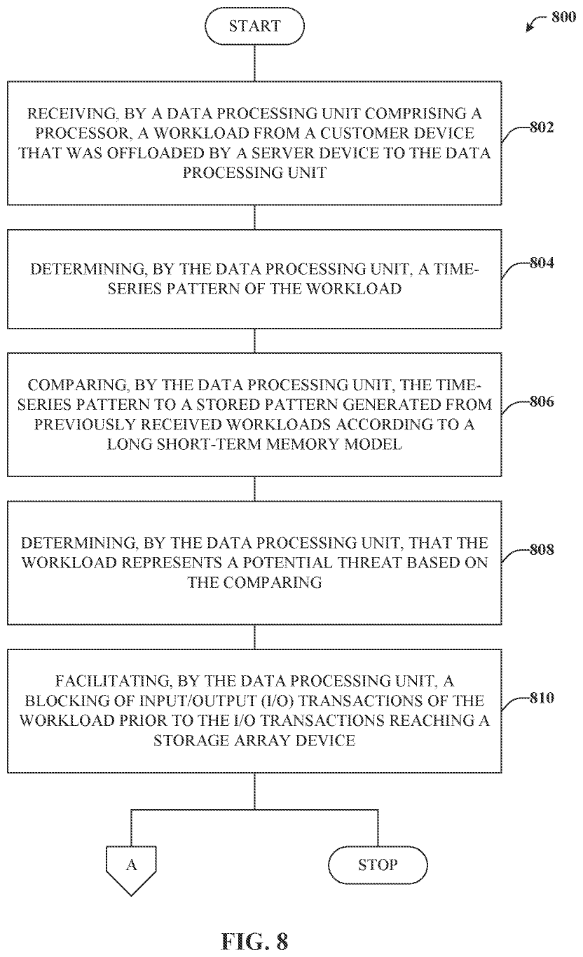

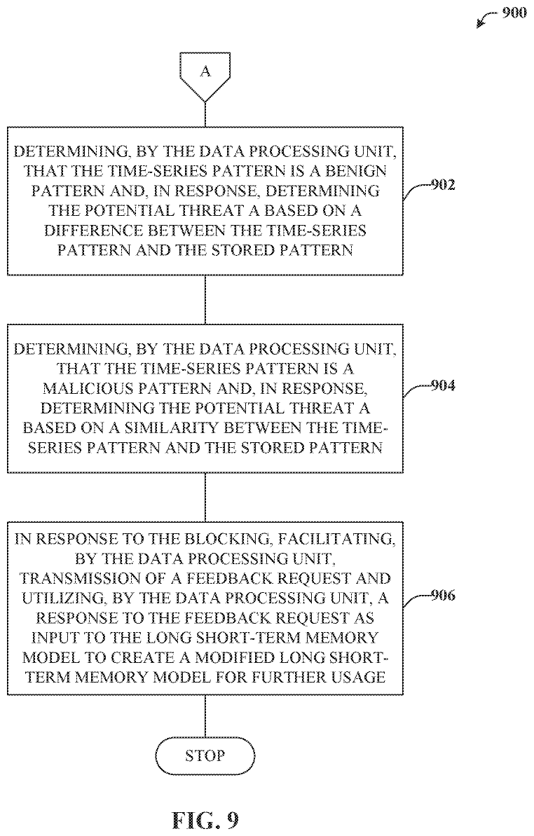

FIGS. 8 and 9 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored in an article of manufacture to facilitate transporting and transferring such methods to computers.

Referring now to FIG. 8, exemplary method 800 is depicted. Method 800 can provide threat detection and mitigation based on an LSTM model running in a DPU in accordance with certain embodiments of this disclosure. While method 800 describes a complete method, in some embodiments, method 800 can include one or more elements of method 900, as illustrated by insert A.

At reference numeral 802, a data processing unit comprising a processor can receive a workload from a customer device that was offloaded by a server device to the data processing unit.

At reference numeral 804, the data processing unit can determine a time-series pattern of the workload. As indicated previously, a time-series pattern can include a time dimension and can establish or involve an order or sequence for data or events.

At reference numeral 806, the data processing unit can compare the time-series pattern to a stored pattern generated from previously received workloads according to a long short-term memory model. The stored pattern can be generated based on customer workloads or training workloads.

At reference numeral 808, the data processing unit can determine that the workload represents a potential threat based on the comparing. For example, a comparison between the two time-series patterns can result in a match (e.g., all comparison element bits match) or a mismatch (e.g., not all comparison element bits match).

At reference numeral 810, the data processing unit can facilitate a blocking of IO transactions of the workload prior to the IO transactions reaching a storage array device. Method 800 can terminate or, in some embodiments, proceed to insert A, which is further detailed in connection with FIG. 9.

Turning now to FIG. 9, exemplary method 900 is depicted. Method 900 can provide for additional aspect or elements in connection with threat detection and mitigation based on an LSTM model running in a DPU in accordance with certain embodiments of this disclosure.

At reference numeral 902, the device introduced at reference numeral 802 comprising a processor can determine that the time-series pattern is a benign pattern and, in response, determine the potential threat a based on a difference between the time-series pattern and the stored pattern.

At reference numeral 904, the device can determine that the time-series pattern is a malicious pattern and, in response, determine the potential threat a based on a similarity between the time-series pattern and the stored pattern.

At reference numeral 906, in response to the blocking detailed at reference numeral 810, the device can facilitate transmission of a feedback request and utilize a response to the feedback request as input to the long short-term memory model to create a modified long short-term memory model for further usage.

### Example Operating Environments

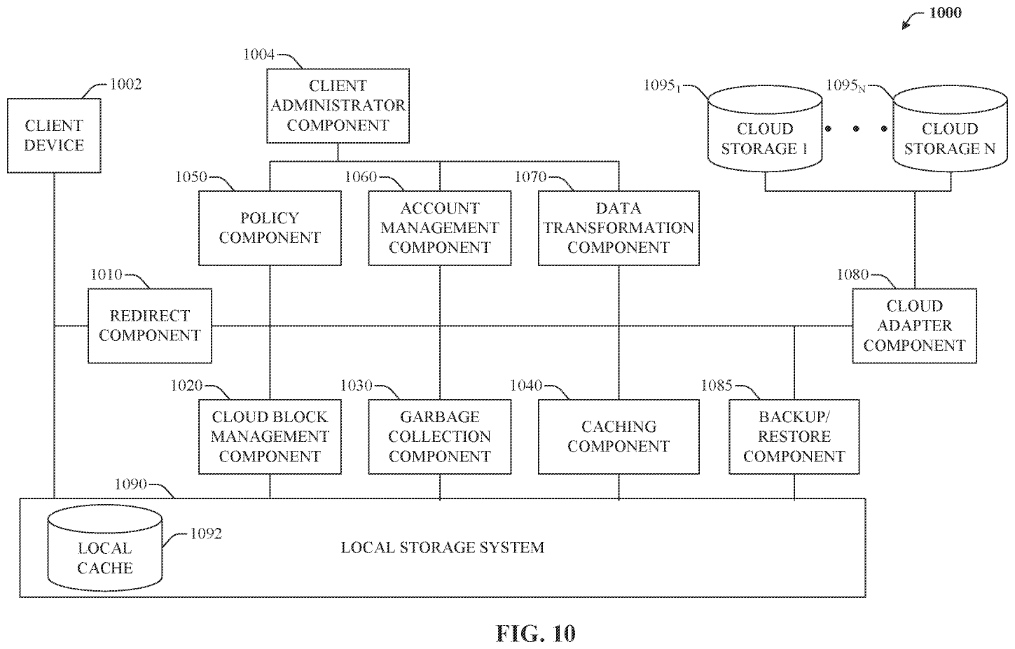

To provide further context for various aspects of the subject specification, FIGS. 10 and 11 illustrate, respectively, a block diagram of an example distributed file storage system 1000 that employs tiered cloud storage and block diagram of a computer 1102 operable to execute the disclosed storage architecture in accordance with aspects described herein.

Referring now to FIG. 10, there is illustrated an example local storage system including cloud tiering components and a cloud storage location in accordance with implementations of this disclosure. Client device 1002 can access local storage system 1090. Local storage system 1090 can be a node and cluster storage system such as an EMC Isilon Cluster that operates under OneFS operating system. Local storage system 1090 can also store the local cache 1092 for access by other components. It can be appreciated that the systems and methods described herein can run in tandem with other local storage systems as well.

As more fully described below with respect to redirect component 1010, redirect component 1010 can intercept operations directed to stub files. Cloud block management component 1020, garbage collection component 1030, and caching component 1040 may also be in communication with local storage system 1090 directly as depicted in FIG. 10 or through redirect component 1010. A client administrator component 1004 may use an interface to access the policy component 1050 and the account management component 1060 for operations as more fully described below with respect to these components. Data transformation component 1070 can operate to provide encryption and compression to files tiered to cloud storage. Cloud adapter component 1080 can be in communication with cloud storage 1 1095₁ and cloud storage N 1095_{N}, where N is a positive integer. It can be appreciated that multiple cloud storage locations can be used for storage including multiple accounts within a single cloud storage location as more fully described in implementations of this disclosure. Further, a backup/restore component 1085 can be utilized to back up the files stored within the local storage system 1090.

Cloud block management component 1020 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 1020 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 1060 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 1020 based on list of mappings it manages. For example, each stub can be associated with an account, and the cloud block management component 1020 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 1080 manages the sending and receiving of data to and from the cloud service providers. The cloud adapter component 1080 can utilize a set of APIs. For example, each cloud service provider may have provider specific API to interact with the provider.

A policy component 1050 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 1030. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 1030 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 1040 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 1020, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 1040 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 1040 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that it has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time it is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 1070 can encrypt and/or compress data that is tiered to cloud storage. In relation to encryption, it can be appreciated that when data is stored in off-premises cloud storage and/or public cloud storage, users can require data encryption to ensure data is not disclosed to an illegitimate third party. In one implementation, data can be encrypted locally before storing/writing the data to cloud storage.

In one implementation, the backup/restore component 1085 can transfer a copy of the files within the local storage system 1090 to another cluster (e.g., target cluster). Further, the backup/restore component 1085 can manage synchronization between the local storage system 1090 and the other cluster, such that, the other cluster is timely updated with new and/or modified content within the local storage system 1090.

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1194 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 1102.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an aspect, when a processor executes instructions to perform “operations”, this could include the processor performing the operations directly and/or facilitating, directing, or cooperating with another device or component to perform the operations.

In the subject specification, terms such as “data store,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated aspects of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A data processing unit, comprising:
a processor; and
a memory that stores executable instructions that, when executed by the processor, facilitate performance of operations, comprising:
receiving a workload from a customer device that was offloaded by a server device to the data processing unit;
determining a time-series pattern represented in the workload;
comparing the time-series pattern to a baseline pattern generated from previously received workloads according to a long short-term memory model; and
in response to an anomaly being detected in the time-series pattern relative to the baseline pattern, performing a blocking procedure that blocks input/output (I/O) transactions of the workload prior to the I/O transactions reaching a storage array device.

2. The data processing unit of claim 1, wherein the long short-term memory model comprises multiple layers of memory cells configured for scanning or forecasting short term and long term trends, seasonalities, or other time-series characteristics.

3. The data processing unit of claim 1, wherein the time-series pattern is determined in response to an examination of time-series data relating to the I/O transactions of the workload.

4. The data processing unit of claim 3, wherein the time-series data comprises at least one of: compression ratio data indicative of compression ratios of the I/O transactions over time, criticality data indicative of a priority or weight associated with an element of the time-series data, size data indicative of data sizes associated with the I/O transactions over time, type data indicative of types of the I/O transactions over time, or distribution data indicative of a distribution of the types of the I/O transactions over time.

5. The data processing unit of claim 1, wherein the operations further comprise comparing the time-series pattern to a malicious pattern, of a malicious workload, generated according to the long short-term memory model.

6. The data processing unit of claim 5, wherein the operations further comprise, in response to a match being detected in the time-series pattern relative to the malicious pattern, performing the blocking procedure that blocks malicious I/O transactions of the malicious workload prior to the malicious I/O transactions reaching the storage array device.

7. The data processing unit of claim 1, wherein the blocking procedure blocks the I/O transactions immediately upon detection or after a defined amount of time based on a policy of a customer entity associated with the customer device.

8. The data processing unit of claim 1, wherein the blocking procedure further comprises transmitting a feedback request message to the customer device and the long short-term memory model uses a response to the feedback request for training or refinement.

9. The data processing unit of claim 1, wherein the long short-term memory model generates workload patterns that are specific to a specified customer entity, the customer device, or a specified application executing on the customer device.

10. The data processing unit of claim 1, wherein the long short-term memory model generates at least one of a first workload pattern associated with a disk wiping operation, a second workload pattern associated with a database update that is specific to a type of database, a third workload pattern associated with disk defragmentation, a fourth workload pattern indicative of on a number of overwrites after reading a specific block or track within a time slice, a fifth workload pattern indicative of a fraction of overwritten blocks relative to a total number of write requests in a specified time window, a sixth workload pattern indicative of an amount of overwriting for the specified time window consisting of multiple time slices, a seventh workload pattern indicative of an average I/O length of continuously overwritten blocks in the specified time window, or an eighth workload pattern indicative of a fraction of a first number of overwrites during the specified time window as a function of an average number of overwrites of a previous time window.

11. A data processing unit, comprising:
a processor; and
a memory that stores executable instructions that, when executed by the processor, facilitate performance of operations, comprising:
receiving a workload from a customer device that was offloaded by a server device to the data processing unit;
determining a time-series pattern applicable to the workload;
comparing the time-series pattern to a malicious pattern generated from previously received workloads according to a long short-term memory model; and
in response to a match being detected in the time-series pattern relative to the malicious pattern, initiating blocking of input/output (I/O) transactions of the workload prior to the I/O transactions reaching a storage array device.

12. The data processing unit of claim 11, wherein the operations further comprise comparing the time-series pattern to a benign pattern, of a benign workload, generated according to the long short-term memory model.

13. The data processing unit of claim 12, wherein the operations further comprise, in response to an anomaly being detected in the time-series pattern relative to the benign pattern, initiating the blocking of the I/O transactions of the workload prior to the I/O transactions reaching the storage array device.

14. The data processing unit of claim 11, wherein initiating the blocking comprises initiating the blocking of the I/O transactions upon detection of the match.

15. The data processing unit of claim 11, wherein initiating the blocking comprises initiating the blocking of the I/O transactions after a defined amount of time based on a policy corresponding to a customer entity associated with the customer device.

16. The data processing unit of claim 11, wherein the blocking comprises transmitting a feedback request message to the customer device and wherein the long short-term memory model uses a response to the feedback request for training or refinement.

17. A method, comprising:
receiving, by a data processing unit comprising a processor, a workload from a customer device that was offloaded by a server device to the data processing unit;
determining, by the data processing unit, a time-series pattern of the workload;
comparing, by the data processing unit, the time-series pattern to a stored pattern generated from previously received workloads according to a long short-term memory model;
determining, by the data processing unit, that the workload represents a potential threat based on the comparing; and
facilitating, by the data processing unit, a blocking of input/output (IO) transactions of the workload prior to the I/O transactions reaching a storage array device.

18. The method of claim 17, further comprising determining, by the data processing unit, that the time-series pattern is a benign pattern and, in response, determining the potential threat a based on a difference between the time-series pattern and the stored pattern.

19. The method of claim 17, further comprising determining, by the data processing unit, that the time-series pattern is a malicious pattern and, in response, determining the potential threat a based on a similarity between the time-series pattern and the stored pattern.

20. The method of claim 17, further comprising, in response to the blocking, facilitating, by the data processing unit, transmission of a feedback request and utilizing, by the data processing unit, a response to the feedback request as input to the long short-term memory model to create a modified long short-term memory model for further usage.
